(19) United States
(12) Patent Application Publication
(10) Pub. No.: US 2026/0310338 A1
(43) Pub. Date: Oct. 8, 2026

(54) METHOD FOR PROVIDING CHANNEL PROFILE AND ELECTRONIC DEVICE SUPPORTING THE SAME

(71) Applicant: KAKAO CORP., Jeju-si (KR)

(72) Inventors: Ja Hyun BAE, Seongnam-si (KR); So Yon SUNG, Seongnam-si (KR); Hye Jin KIM, Seongnam-si (KR)

(21) Appl. No.: 19/639,751

(22) Filed: Apr. 6, 2026

(30) Foreign Application Priority Data
Apr. 8, 2025 (KR) 10-2025-0045309

(51) Int. Cl. G06F 3/0484; G06F 3/0482; G06F 3/0488; G06Q 10/40

(52) U.S. Cl. CPC G06F 3/0484; G06F 3/0482; G06F 3/0488; G06Q 10/40

(57) ABSTRACT

A method for providing a channel profile object may include receiving an interaction for activating a user interface including a channel profile object. The method may also include displaying the user interface on a screen of the terminal. The user interface may include a region in which a plurality of profile objects is sequentially arranged and displayed. The plurality of profile objects may include at least one other user profile object updated within a preset period or at least one channel profile object corresponding to at least one channel account. The at least one updated other user profile object may be a user profile object corresponding to at least one other account associated with an account of the terminal.

### CROSS-REFERENCE TO RELATED APPLICATION

This application claims priority to and the benefit of Korean Patent Application No. 10-2025-0045309 filed on Apr. 8, 2025, the disclosure of which is incorporated herein by reference in its entirety.

### BACKGROUND

### Technical Field

The present disclosure relates to a method for providing a channel profile and an electronic device supporting the same.

### Description of Related Technology

In the Internet environment, cultural and leisure activities using blogs, online communities, and personal web pages are increasing. These online communities operate bulletin boards or virtual online content spaces where users can upload text, images, and videos to facilitate smooth information sharing among internet users.

Meanwhile, advertising has been typically conducted through media such as newspapers and magazines, but recently, advertising using personal web pages is rapidly increasing. For example, a blogger who runs a blog may propose ad placement from an advertiser, and the advertiser may evaluate the feasibility of advertising on the blog. Once the advertiser approves the ad placement, the blogger posts the content on the blog. Advertising partnerships that invoice advertisers based on measurable results are becoming more common and are already being offered as fully functional services.

### SUMMARY

The present disclosure provides a method for providing a channel profile corresponding to a channel account, and an electronic device supporting the same.

In one aspect of the present disclosure, a method for providing a channel profile object in a terminal includes: receiving an interaction for activating a user interface comprising the channel profile object; and displaying the user interface on a screen of the terminal. The user interface displays a plurality of profile objects sequentially arranged in a region. The plurality of profile objects includes at least one other user profile object updated within a preset period or at least one channel profile object corresponding to the at least one channel account. The at least one updated other user profile object is a user profile object corresponding to at least one other account associated with an account of the terminal.

According to an embodiment of the present disclosure, the at least one channel profile object has an arrangement position that is determined in the region based on a selection interaction performed on the terminal regarding the at least one updated other user profile object.

According to an embodiment of the present disclosure, the method may further include removing the at least one channel profile object when a preset period has elapsed after displaying the at least one channel profile object in the region.

According to an embodiment of the present disclosure, the method may further include changing the at least one channel profile object to another channel profile object corresponding to the at least one channel account, when a preset period has elapsed after displaying the at least one channel profile object in the region.

According to an embodiment of the present disclosure, the method may further include, in response to a selection interaction for selecting one other profile object among the at least one channel profile object, displaying a channel user interface corresponding to the selected other channel profile object.

According to an embodiment of the present disclosure, the method may further include: receiving a touch swipe interaction with the channel user interface; and in response to the touch swipe interaction, displaying a profile user interface corresponding to one other user profile of the at least one other user profile object, wherein the profile user interface is determined based on an arrangement position of the one other user profile in the region.

According to an embodiment of the present disclosure, the method may further include: receiving an interaction with a channel landing interface included in the channel user interface; displaying a landing user interface corresponding to the channel landing interface; and displaying, in the channel user interface, a channel add interface that supports a function for associating an account of the terminal with a channel account corresponding to the one other channel profile object.

According to an embodiment of the present disclosure, the at least one channel profile object may be determined based on at least one of: gender information of the at least one other user profile object; age information of the at least one other user profile object; and association information with at least one channel corresponding to the at least one channel profile object.

In another aspect of the present disclosure, a terminal for providing a channel profile object includes a memory storing instructions, and a processor configured to execute the instructions to: receive an interaction for activating a user interface comprising the channel profile object; and display the user interface on a screen of the terminal. The user interface displays a plurality of profile objects sequentially arranged in a region. The plurality of profile objects includes at least one other user profile object updated within a preset period or at least one channel profile object corresponding to the at least one channel account. The at least one updated other user profile object corresponds to at least one other account associated with an account of the terminal.

In another aspect of the present disclosure, a method performed by a server for providing a channel profile object include: identifying for at least one other user profile object that has been updated within a preset period, wherein the at least one updated other user profile object is a user profile object corresponding to at least one other account associated with an account of the terminal; providing the at least one updated other user profile object to the terminal; and providing at least one channel profile object corresponding to at least one channel account to the terminal, wherein a user interface of the terminal displays a plurality of profile objects sequentially arranged in a region, the plurality of profile objects comprising the at least one channel profile object and the at least one updated other user profile object.

According to an embodiment of the present disclosure, the at least one channel profile object has an arrangement position that is determined in the region based on a selection interaction performed on the terminal regarding the at least one updated other user profile object.

According to an embodiment of the present disclosure, the method may further include removing the at least one channel profile object when a preset period has elapsed after displaying the at least one channel profile object in the region

According to an embodiment of the present disclosure, the method may further include changing the at least one channel profile object to another channel profile object corresponding to the at least one channel account, when a preset period has elapsed after displaying the at least one channel profile object in the region.

According to an embodiment of the present disclosure, the method may further include, in response to a selection interaction performed on the terminal regarding one other channel profile object among the at least one channel profile object, providing a channel user interface corresponding to the one other channel profile object to the terminal.

According to an embodiment of the present disclosure, the method may further include, in response to a touch swipe interaction performed on the terminal with the channel user interface, providing a profile user interface corresponding to the at least one other user profile object to the terminal, wherein the profile user interface is determined based on an arrangement position of the one other user profile object in the region.

According to an embodiment of the present disclosure, the method may further include, in response to an interaction performed on the terminal regarding a channel landing interface included in the channel user interface, providing a landing user interface corresponding to the channel landing interface to the terminal; and providing, in the channel user interface, a channel add interface that supports a function for associating the account of the terminal with a channel account corresponding to the one other channel profile object.

According to an embodiment of the present disclosure, the at least one channel profile object may be determined based on at least one of: gender information of the at least one other user profile object; age information of the at least one other user profile object; and association information with at least one channel corresponding to the at least one channel profile object.

In yet another aspect of the present disclosure, a server for providing a channel profile object includes a memory storing instructions, and a processor configured to execute the instructions to: identify at least one other user profile object updated within a preset period, wherein the at least one updated other user profile object is a user profile object corresponding to at least one other account associated with an account of the terminal; provide the at least one updated other user profile object to the terminal; and provide at least one channel profile object corresponding to at least one channel account to the terminal, wherein a user interface of the terminal displays a plurality of profile objects sequentially arranged in a region, the plurality of profile objects comprising the at least one channel profile object and the at least one other user profile object.

In yet another aspect of the present disclosure, there is provided a non-transitory computer readable recording medium storing instructions, when executed by one or more processors, configured to perform the method of any one of the methods.

### BRIEF DESCRIPTION OF THE DRAWINGS

FIG. 1 is a diagram illustrating an example of a network environment according to an embodiment of the present disclosure.

FIG. 2 is a flowchart illustrating an example in which a terminal provides a channel profile to an application according to an embodiment of the present disclosure.

FIGS. 3A, 3B, and 3C are diagrams illustrating an example in which a terminal displays a channel profile in an area adjacent to another user profile in a region of a user interface according to an embodiment of the present disclosure.

FIGS. 4A and 4B are diagrams illustrating an example in which a terminal displays a channel profile in an update profile region according to an embodiment of the present disclosure.

FIGS. 5A, 5B, and 5C are diagrams illustrating an example in which a terminal displays a channel profile that changes according to a preset timing, according to an embodiment of the present disclosure.

FIG. 6 is a diagram illustrating an example of a terminal displaying a channel user interface.

FIG. 7 is a diagram illustrating an example in which a terminal displays a channel add interface in a channel user interface.

FIG. 8 is a flowchart illustrating an example in which a server provides a channel profile to an application.

### DETAILED DESCRIPTION

Hereinafter, embodiments of the present disclosure will be described in detail with reference to the accompanying drawings. Regardless of the reference numerals, the same or similar elements are assigned the same reference numerals, and redundant descriptions thereof will be omitted. In the following description, if it is determined that a detailed description of a related known technology may obscure the gist of the embodiments disclosed herein, the detailed description thereof will be omitted

The ordinal terms “first”, “second”, etc. may be used herein to describe various elements, but these elements should not be limited by these terms. These terms are used only to distinguish one element from another.

As used herein, the singular forms “a,” “an,” and “the” are intended to include the plural forms as well, unless the context clearly indicates otherwise.

In the present disclosure, each step described may be performed in any order regardless of the listed order, unless a specific order is required by a particular causal relationship.

In the present application, terms such as “comprise,” “include,” or “have” are intended to specify the presence of features, numbers, steps, operations, elements, components, or combinations thereof described in the specification, and should be understood not to preclude the presence or addition of one or more other features, numbers, steps, operations, elements, components, or combinations thereof.

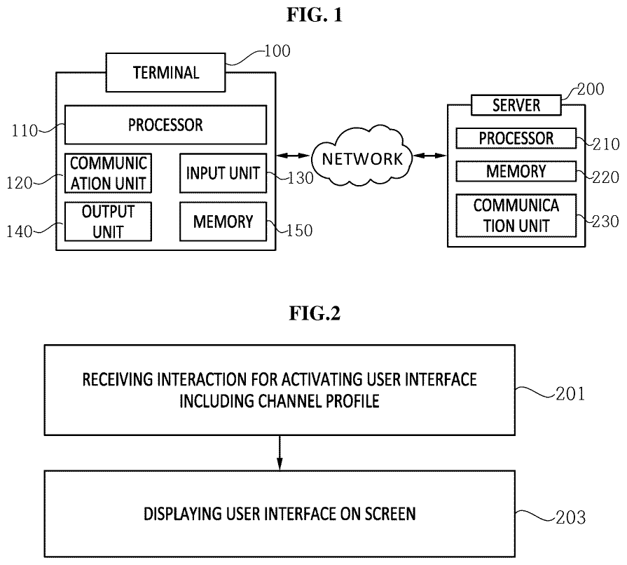

FIG. 1 is a diagram illustrating an example of a network environment according to an embodiment of the present disclosure. Hereinafter, the present disclosure will be described with reference to the accompanying drawings.

According to various embodiments, a terminal 100 may be connected to a server 200 through a network. A communication method for the network is not limited, and the network may include not only communication methods utilizing various communication networks (e.g., a mobile communication network, a wired Internet, a wireless Internet, and a broadcasting network) but also short-range wireless communication.

According to various embodiments, the terminal 100 may include at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device

Referring to FIG. 1, according to various embodiments, the terminal 100 may include a processor 110, a communication unit 120, an input unit 130, an output unit 140, and a memory 150. According to an embodiment, at least one of the aforementioned elements of the terminal 100 may be omitted or another element may be further provided.

The processor 110 may control a number of hardware or software elements connected to the processor 110 by driving an operating system or application program, and may perform various data processing and operations. The processor 110 may execute an application by controlling the overall operation of the communication unit 120, the input unit 130, the output unit 140, and the memory 150. The processor 110 may execute an application by controlling the overall operation of the communication unit 120, the input unit 130, the output unit 140, and the memory 150.

According to various embodiments, the processor 110 may register as a member of an application (e.g., a messenger application providing a chat function, a desktop-based messenger program, etc.) and may participate in a chat room using an account (e.g., an identifier (ID), an email account, etc.) of the terminal 100 that is registered as a member of the application. The chat room may provide a chat function, a voice function, a video function, and the like between different terminals that are registered as members of the application. The chat room may include a private chat room in which participation is restricted to a creator of the chat room and participants invited by the creator, and a public chat room in which participation is permitted through link information publicly posted on a bulletin space or the like, in addition to the creation and invitation by the creator.

According to various embodiments, the processor 110 may display a user interface corresponding to the application in response to an interaction for activating the application. The term “interaction” may include a touch on a touchscreen, a mouse click, typing on a keyboard, a sound input through a microphone, an image capture via a camera, motion recognition through a motion sensor, or the like.

According to an embodiment, the user interface may include at least one user profile corresponding to at least one other account that has been updated within a preset period among at least one other account associated with an account of the terminal 100 (e.g., an account having a friend relationship with the account of the terminal 100). For example, among the account “Peter” of the terminal 100 and the friend accounts “Jane,” “Mary,” and “John,” the processor 110 may display the user profile of “Mary,” whose user profile has been updated within 24 hours after activating the application. In another example, the processor 110 may display the user profile of “Mary” whose user profile has been updated within a time preset by the server 200.

A user profile may be a graphical user interface (GUI) that represents each account (e.g., peter**@kakao. com, jane**@kakao. com) registered as a member of the application when a corresponding account performs functions provided by the application, such as a chat function. For example, the user profile of each account may include at least one of text, an image, an emoticon, or a video.

Updating a user profile may mean changing a background, a representative image, a text, profile status information, or the like, which constitutes a user profile of each account in the application (e.g., the user profile of “Mary”). In addition, updating a user profile may mean sharing a text, an image, a video, an emoticon, or the like, which constitutes the user profile of each account, with at least one other account.

According to an embodiment, a user interface corresponding to the application may include at least one channel profile object corresponding to at least one channel account. At least one channel account may be a business account (e.g., a corporate account, a brand account, etc.) that shares brand information, product launch information, technical support information, customer service information, promotional information, or discount event information with customer accounts (e.g., a general personal account, a general consumer account, etc.) through an online channel of the application. The online channel of the application may be a business channel that supports sharing of various contents between the business account and at least one other account (e.g., a customer account, a friend account, etc.) and supports a chat function for transmitting and receiving messages.

According to an embodiment, at least one channel profile object corresponding to at least one channel account included in a user interface may be displayed together within a region of the user interface where at least one user profile corresponding to at least one other account (e.g., a friend account of the account of the terminal 100) is displayed. For example, the processor 110 may display a channel profile object (e.g., a “flower shop” channel profile object, a “jewelry” channel profile object, etc.) in a region of the user interface where a user profile of “Peter,” who is a friend account of the account of the terminal 100, is displayed. For example, the processor 110 may sequentially display first and second accounts and the channel profile object, for each of which a user profile has been updated, at intervals of a preset distance (e.g., 0.1 cm, 0.5 cm, 1 cm, etc.) within a region of the user interface.

The communication unit 120 may establish communication between the terminal 100 and an external electronic device. For example, the communication unit 120 may be connected to a network through wireless communication or wired communication to communicate with an external electronic device (e.g., an external server) or the server 200.

The input unit 130 may serve as an interface capable of transmitting commands or data input from a user or another external device to other element(s) of the terminal 100. In addition, the input unit 130 may output commands or data received from other element(s) of the terminal 100 to the user or another external device. For example, the input unit 130 may be a touch screen module, a keyboard, a mouse, a button, a camera, a stylus, a microphone, and the like.

The terminal 100 may receive a user interaction through the input unit 130. The term “interaction” as used herein may refer to inputting information, which reflects a user's selection or intention, into the terminal 100 by the user manipulating the input unit 130.

The output unit 140 may output various information. The output unit 140 may be a display, a touch screen, a speaker, a vibration generating device, a tactile generating device, and the like. The output unit 140 may, for example, display various contents (e.g., text, images, videos, icons, or symbols) to the user. According to various embodiments, the output unit 140 may be a device (e.g., a Bluetooth earphone) that is connected to the terminal 100 through wired or wireless communication (e.g., short-range wireless communication such as Bluetooth) to receive and output a signal.

The memory 150 functions as a storage medium and may store a plurality of application programs executed on the terminal 100, and data and instructions for the operation of the terminal 100. The memory 150 may be implemented in various forms of hardware storage devices, such as a read only memory (ROM), a random access memory (RAM), a flash drive, a hard drive, and the like, or may be provided in the form of web storage. According to an embodiment, an application related to a messenger service (hereinafter referred to as ‘application’) may be stored in the memory 150.

According to various embodiments of the present disclosure, the server 200 may be implemented as a single computer device or a plurality of computer devices that provide commands, codes, files, content, services, etc. The server 200 may be a server that may transmit and receive information by communicating with the terminal 100 through a network.

According to various embodiments, the server 200 may be a device that provides the application to the terminal 100. The application may refer to a service that allows a plurality of accounts to send or receive messages to each other through a platform provided by the server 200. Each message may include all transmittable data, such as a text, a photo, a video, a voice file, an emoticon, and the like.

According to various embodiments, the server 200 may be connected to the terminal 100 through a network. A communication method for the network is not limited, and the network may include not only communication methods utilizing various communication networks (e.g., a mobile communication network, a wired Internet, a wireless Internet, and a broadcasting network) but also short-range wireless communication.

The server 200 according to various embodiments of the present disclosure may be implemented as a computer device or a plurality of computer devices that provide commands, codes, files, contents, services, etc. According to an embodiment, the server 200 may be an electronic device capable of transmitting and receiving information by communicating with the terminal 100 through a network. Although the server 200 is described as a single server for convenience of explanation, the server 200 may include a plurality of servers, and each of the plurality of servers may provide different functions or services.

According to various embodiments, when the terminal 100 needs to perform a specific function or service automatically or upon a request, the terminal 100 may request the server 200 to perform at least one function associated therewith, instead of or in addition to executing the specific function or service by itself. The server 200 may execute a requested function or an additional function and provide a result thereof to the terminal 100. The terminal 100 may provide the requested function or service by providing the received result as is or after further processing the same. For example, cloud computing, distributed computing, or client-server computing technologies may be utilized.

The server 200 may include a processor 210, a memory 220, and a communication unit 230. The processor 210 may control the overall operations of the memory 220 and the communication unit 230. According to various embodiments of the present disclosure, the memory 220 functions as a storage medium and may store a plurality of application programs running on the server 200, and data and instructions for the operation of the server 200. According to an embodiment, the memory 220 may be implemented in various forms of hardware storage devices, such as read only memory (ROM), random access memory (RAM), a flash drive, a hard drive, and the like, or may be provided in the form of web storage. The communication unit 230 may communicate with the terminal 100 through a network in a wired or wireless manner.

According to various embodiments, the server 200 may provide an application to the terminal 100. According to an embodiment, an external device (e.g., a server 200, an external server linked to the server 200, a third-party server, etc.) may provide a relevant function or a user interface such that the terminal 100 or the external terminal may download various applications that provide chat functions, voice call functions, and/or map service functions. For example, the application may include a preloaded application or a third party application downloadable from the server 200.

According to various embodiments, the processor 210 may identify information on a user profile of each account registered as a member of the application. For example, the processor 210 may identify user profile information (e.g., an account identifier (ID), user profile background information, status information, etc.) of “Peter”, which is an account registered as a member of the application. In addition, the processor 210 may identify whether the user profile information of the account “Peter” has been updated. For example, the processor 210 may determine that a background image of a user profile of the account “Peter” has been changed. As another example, the processor 210 may determine that the account “Peter” has posted a video content of less than one minute to be shared with another account.

According to an embodiment, the processor 210 may identify at least one user profile corresponding to at least one other account that has been updated within a preset period among at least one other account associated with the account of the terminal 100. For example, the processor 210 may determine whether any of the friend accounts such as “Peter”, “Jane”, and “Mary” associated with the account of the terminal 100 has updated a user profile within the last 12 hours. In the above example, if the friend account “Jane” associated with the terminal 100 changes a background image of a user profile, the processor 210 may identify information on the change of the user profile of “Jane.”

According to an embodiment, the processor 210 may provide at least one updated user profile to the terminal 100. For example, when it is determined that “Jane”, among the friend accounts such as “Peter,” “Jane,” and “Mary” has updated a user profile within the last 12 hours, the processor 210 may provide a relevant function or a user interface such that the user profile of “Jane” is displayed as an updated friend profile on a user interface.

According to various embodiments, when a first account of an application requests registration as a channel account (e.g., a business account), the processor 210 may provide a registration user interface for receiving basic information (e.g., a company name, a business registration number, etc.), an identifier (ID), a password, and the like. After the first account is registered as a business account, the processor 210 may provide a relevant user interface that enables the business account to perform functions such as a log-in function and an account management function. For example, when the account of the terminal 200 (e.g., dho**kp@kakao. com, dfoadsh&&@kakao. com, etc.) requests registration as a business account, the processor 210 may provide a user interface that supports a membership registration function, a log-in function, an account management function, and the like.

A channel of the application may be a business channel created by a channel account (e.g., a business account). For example, a business channel may be an online platform (e.g., an “A restaurant” business channel, a “B flower shop” business channel, etc.) where a channel account sells or provides products and/or services related to advertising, education, entertainment, travel, and the like. The business channel may include industry category information, business hours information, location information, contact information (e.g., phone number, email address, etc.), product information, service information, order and delivery information, promotion and event information, customer review information, link information (e.g., an URL address linking to a website or social media page), and the like included in the business channel. In addition, the business channel may include an advertising content that is used to deliver products and/or services-related information included in the business channel to each account of the application (e.g., a customer account, a general consumer account, etc.).

According to various embodiments, the processor 210 may provide at least one channel profile object corresponding to at least one channel account to the terminal 100. According to an embodiment, the processor 210 may provide a relevant function or a user interface such that at least one channel profile object corresponding to at least one channel account is displayed on a user interface displayed by the terminal 100. For example, the processor 210 may provide a relevant function or a user interface such that a user profile of “Jane” and a channel profile object of “A flower shop”, each of which has been updated, are displayed together in a region of the user interface.

According to an embodiment, the processor 210 may provide a relevant function or a user interface such that at least one channel profile object is displayed together within a region of the user interface where at least one user profile is displayed. For example, the processor 210 may provide a relevant function or a user interface such that a channel profile object is displayed within a region of the user interface at intervals (e.g., 0.1 cm, 0.2 cm, etc.) equal to the intervals at which respective user profiles of updated friend accounts are displayed.

FIG. 2 is a flowchart illustrating an example in which the terminal 100 provides a channel profile object in an application according to an embodiment of the present disclosure.

In operation 201, the terminal 100 may receive an interaction for activating a user interface including a channel profile object. According to an embodiment, in response to an interaction for activating the application, the terminal 100 may display a user interface corresponding to the application on the screen of the terminal 100.

In operation 203, the terminal 100 may display a user interface on a screen of the terminal 100. According to an embodiment, in response to an interaction for activating the application, the terminal 100 may display a user interface corresponding to the application on the screen of the terminal 100.

According to various embodiments, the user interface corresponding to the application may include user profile information corresponding to an account of the terminal 100 registered as a member of the application, and other user profile information corresponding to at least one other account associated with the account of the terminal 100. For example, the user interface corresponding to the application may include user profile information for “Peter”, which is the account of the terminal 100, and a list of other user profiles corresponding to “John”, “Jane”, and “Mary”, which are at least one other account associated with the user account “Peter” of the terminal 100.

User profile information corresponding to the account of the terminal 100 may include image information (e.g., a background image of the user profile), status information (e.g., a text, an image, and the like input by the user of the terminal 100), audio information, video information, and the like, which are selected by a user of the terminal 100.

At least one other account associated with the account of the terminal 100 may be an account that has established a preset relationship with the account of the terminal 100 within the application. For example, the terminal 100 may establish a preset relationship with the account “John”, by storing phone number information, identifier (ID) information, or the like corresponding to “John,” which is an account different from the account “Jane” of the terminal 100. As another example, the terminal 100 requests the account “John” to establish a friend relationship within the application, and when the account “John” approves the request, a preset relationship may be established between the account “Jane” of the terminal 100 and the account “John.”

According to various embodiments, when at least one other user profile object corresponding to at least one other account associated with the account of the terminal 100 has been updated within a preset period, the terminal 100 may display the at least one updated other user profile object distinguishably from other user profiles that have not been updated. For example, if, among a second account, a third account, a fourth account, and a fifth account, each of which has established a preset relationship with the account of the terminal 100, the second and fourth accounts have updated user profile information (e.g., image information, status information, etc.) within a preset period (e.g., within the last 6 hours or the last 24 hours), the terminal 100 may separately display the user profile information corresponding to each of the second and fourth accounts in a region of the user interface.

According to various embodiments, the terminal 100 may display at least one channel profile object corresponding to at least one channel account in a region of the user interface. At least one channel account may refer to a business account that creates a business channel (e.g., an “A restaurant” business channel, a “B flower shop” business channel, etc.). A business channel may include an advertising content for delivering information related to products and/or services included in the business channel to each account (e.g., a customer account, a general consumer account, etc.) of the application. A channel profile object may include information representing logo image information of the business channel, industry category information, business hours information, location information, contact information (e.g., a phone number and an email address), product information, service information, order and delivery information, promotion and event information, customer review information, link information (e.g., a URL address linking to a website or social media page), and the like.

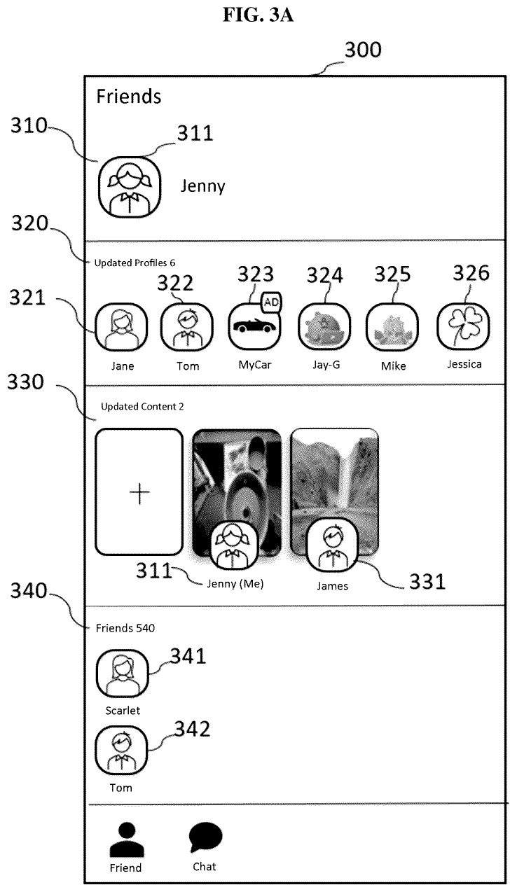

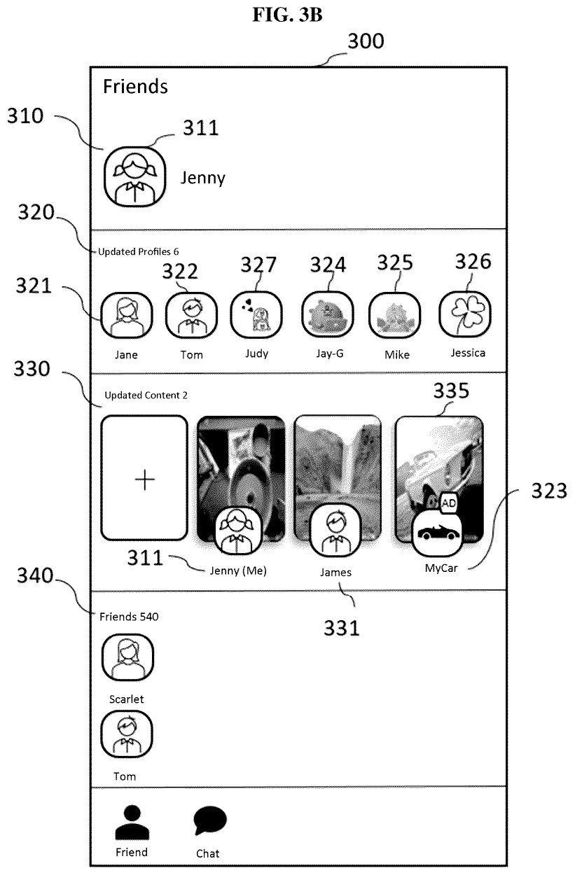

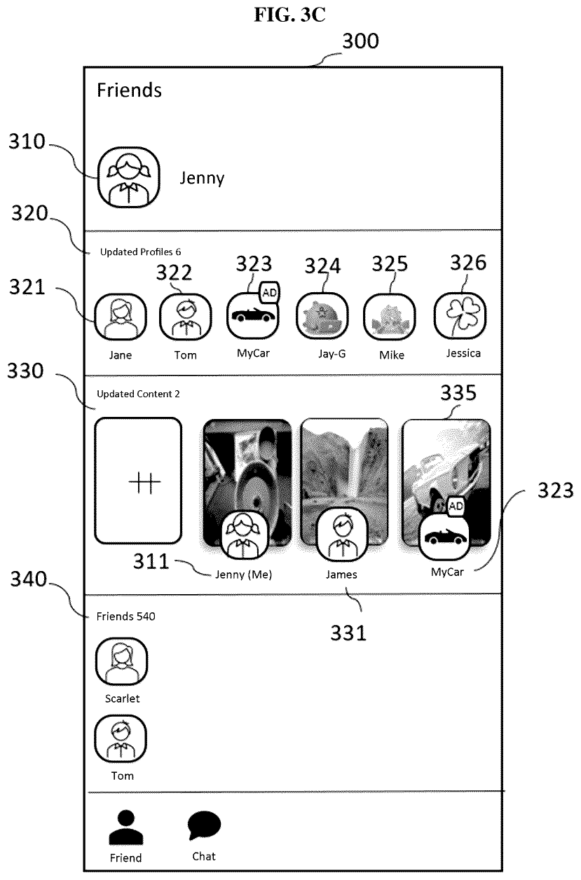

FIGS. 3A to 3C are diagrams illustrating an example in which the terminal 100 displays a channel profile object in a region of a user interface 300, specifically in a region adjacent to another user profile, according to an embodiment of the present disclosure.

Referring to FIG. 3A, the terminal 100 may display, on a screen thereof, the user interface 300 corresponding to an application supporting a chat function.

According to various embodiments, the user interface 300 may include a profile region 310, an update profile region 320, an update content region 330, and a friend list region 340. The regions 310, 320, 330, and 340 included in the user interface 300 are not limited to the above examples, and some of the regions may be omitted or another region may be added.

According to an embodiment, the terminal 100 may display a profile 311 of the account of the terminal 100 in the profile region 310. The profile 311 of the account of the terminal 100 may include an image, text, status information of the account, a name, and the like.

According to an embodiment, the terminal 100 may display, in the update profile region 320, other user profile objects 321, 322, 324, 325, and 326 and a channel profile object 323, each of which has been updated within a preset period. For example, among other accounts that have established a friend relationship with an account “Jenny” of the terminal 100, the terminal 100 may display, in the update profile region 320, the other user profile objects 321, 322, 324, 325, and 326 that have updated profile information within the last 24 hours. In addition, the terminal 100 may display the channel profile object 323 between a user profile object 322 of “Tom” and a user profile object 324 of “Jay-G” at intervals at which each of the other user profile objects is displayed.

According to an embodiment, the terminal 100 may display, in the update content region 330, the profile 311 of the account of the terminal 100 and another user profile object 331 that have uploaded content within a preset period. When an account posts a text, a video, an emoticon, an image, or the like, the application may provide a function of sharing the same with other accounts that have established a friend relationship with the corresponding account. For example, when the account of the terminal 100 or another user account requests sharing of video content within the last 24 hours, the terminal 100 may display a profile name of each of the accounts and the video content posted by each of the accounts in the update content region 330.

According to an embodiment, the terminal 100 may display a list of friend accounts that have established a preset relationship with the account of the terminal 100 in the friend list region 340. The list of friend accounts may include the number of friend accounts (e.g., 540) that have established a friend relationship with the account of the terminal 100, profiles 341 and 342 of the friend accounts, and the like.

Referring to FIG. 3B, the terminal 100 may display, in the update profile region 320, other user profile objects 321, 322, 324, 325, 326, and 327, each of which has been updated within a preset period. The terminal 100 may display, in the update content region 330, the profile 311 of the account of the terminal 100, another user profile object 331, and the channel profile object 323, each of which has uploaded content within a preset period. For example, when a channel account requests sharing of advertising content within the last 24 hours, the terminal 100 may display the channel profile object 323 and the advertising content 335 posted by the channel account in the update content region 330.

Referring to FIG. 3C, the terminal 100 may display together, in the update profile region 320, other user profile objects 321, 322, 324, 325, and 326 and the channel profile object 323, each of which has been updated within a preset period. In addition, the terminal 100 may display together, in the update content region 330, the profile 311 of the account of the terminal 100, another user profile object 331, and the channel profile object 323, each of which has uploaded content within a preset period.

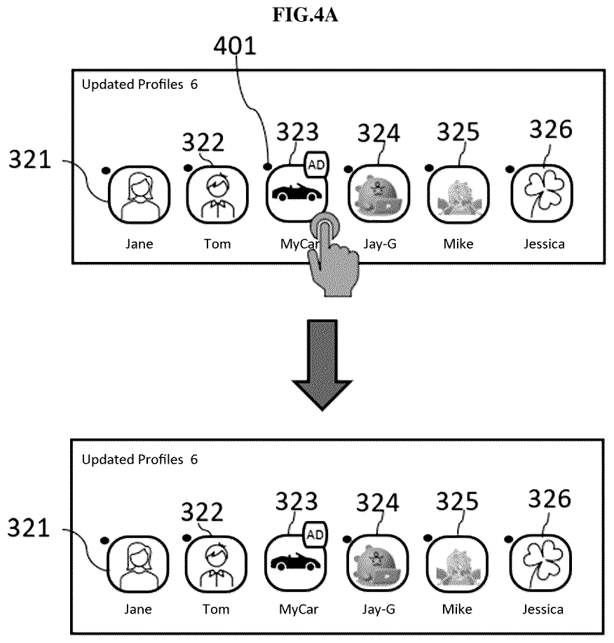

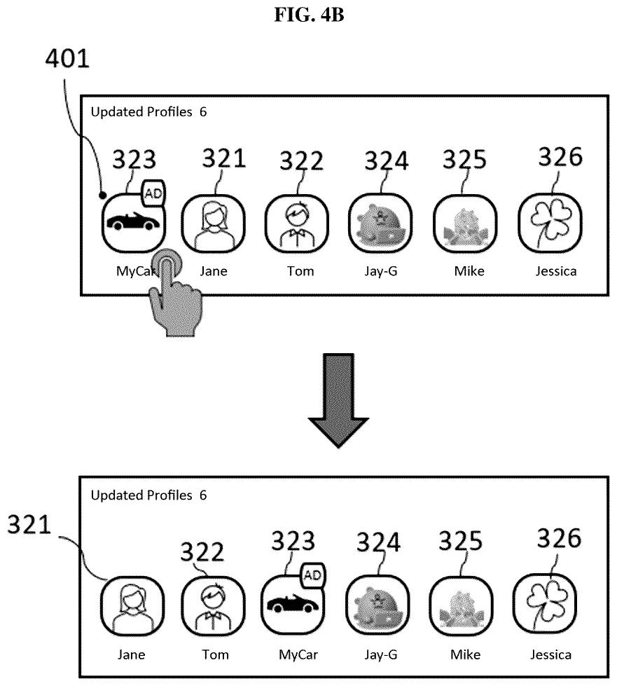

FIGS. 4A and 4B are diagrams illustrating an example in which the terminal 100 displays a channel profile object 323 in an update profile region 320.

According to various embodiments, the terminal 100 may display, in a region adjacent to a region where other user profile objects 321, 322, 324, 325, and 326 and a channel profile object 323 are displayed, a selection image 401 representing whether an interaction is performed regarding each profile. The selection image 401 may represent whether the terminal 100 has interacted with each profile displayed in the update profile region 320. For example, when an interaction with one other user profile object 321 is identified, the terminal 100 may display the other user profile corresponding to the user profile object 321 without the selection image 401.

According to various embodiments, a position of the channel profile object 323 to be displayed in the user interface may be determined based on whether an interaction is performed regarding at least one other user profile object 321, 322, 324, 325, or 326 and the channel profile object 323, each of which has been updated.

Referring to FIG. 4A, when the terminal 100 receives an interaction with the channel profile object 323, the terminal 100 may display the channel profile object 323 without the selection image 401, and may maintain the position of the channel profile object 323 sequentially displayed in the update profile region 320. For example, when a total number of user profiles in the update profile region 320 is greater than or equal to a preset number (e.g., 2, 3, 4, or 5), the terminal 100 may fix and display the channel profile object 323 at a predetermined position (e.g., first, second, third, fourth, or fifth) from one side (e.g., a left side or a right side based on the screen of the terminal 100). As another example, when a total number of user profiles in the update profile region 320 is less than or equal to a preset number (e.g., 1, 2, or 3), the terminal 100 may fix and display the channel profile object 323 at a predetermined position (e.g., a first, second, third, fourth, or fifth position) from one side (e.g., a left side or a right side based on the screen of the terminal 100).

As yet another example, the terminal 100 may fix and display the channel profile object 323 at a predetermined position (e.g., a first, second, third, fourth, or fifth position) from one side (e.g., a left side or a right side based on the screen of the terminal 100). As yet another example, the terminal 100 may change a display position of the channel profile object 323 depending on whether an interaction with the channel profile object 323 is received. In the above example, as the interaction with the channel profile object 323 is identified, the terminal 100 may change a display position of the channel profile object 323, which is currently displayed at a third position on the screen, to a first position. As yet another example, the channel profile object 323 may be displayed at a random position within the update profile region 320 without being limited to a predetermined position.

Referring to FIG. 4B, when an interaction with each of the at least one updated other user profile objects 321, 322, 324, 325, or 326 is identified, the terminal 100 may remove all selection images 401 positioned in a region adjacent to each of the respective profiles. In this case, the terminal 100 may fix a display position of the channel profile object 323 within the update profile region 320 to a first position from one side (e.g., a left side of the screen). Thereafter, when receiving an interaction with the channel profile object 323, the terminal 100 may remove the selection image 401 positioned in a region adjacent to the channel profile object 323 and fix and display the channel profile object 323 at a predetermined position (e.g., a first, second, third, fourth, or fifth position) from one side (e.g., a left side or a right side based on the screen).

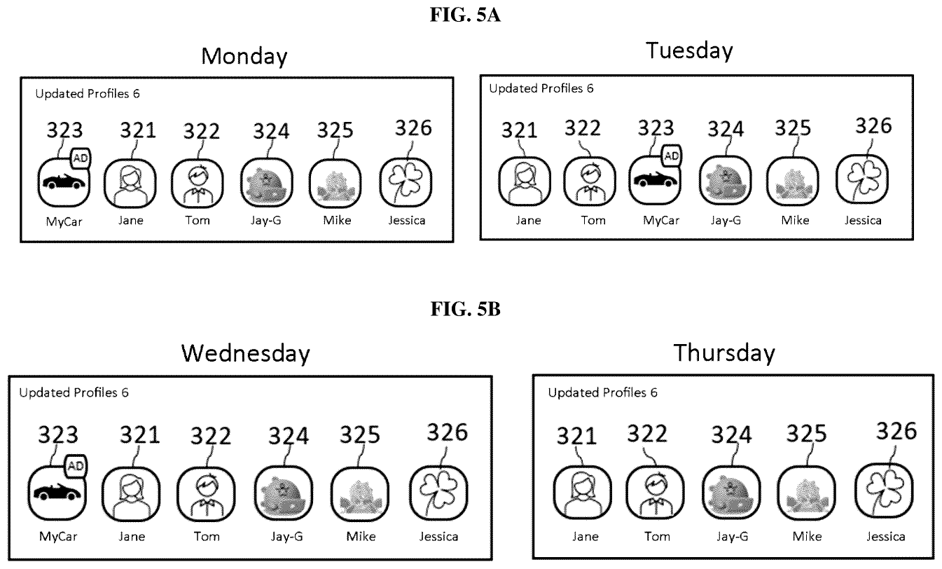

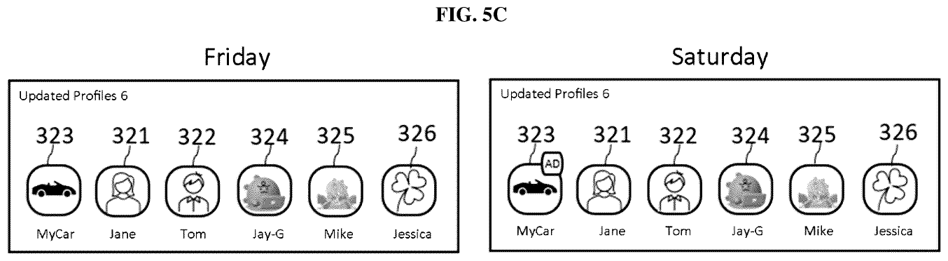

FIGS. 5A to 5C are diagrams illustrating an example in which the terminal 100 displays a channel profile object that changes according to a preset timing, according to an embodiment of the present disclosure.

Referring to FIG. 5A, the terminal 100 may determine a position of the channel profile object 323 displayed in the update profile region 320 according to a preset timing. For example, when the application is activated on Monday, the terminal 100 may arrange the channel profile object 323 at a first position from the left side of the screen of the terminal 100. In the above example, when the application is activated on Tuesday, the terminal 100 may arrange the channel profile object 323 at a third position from the left side of the screen of the terminal 100. The preset timing may be Monday, Tuesday, Wednesday, Thursday, Friday, Saturday, Sunday, weekend, a first week of every month, or the like. In addition, the display position of the channel profile object 323 determined according to the preset timing may be set or changed by the terminal 100 and/or the server 200.

Referring to FIG. 5B, the terminal 100 may determine whether to display the channel profile object 323 based on the preset timing. For example, when the application is activated on Wednesday, the terminal 100 may display the channel profile object 323 in the update profile region 320, and when the application is activated on Thursday, the terminal 100 may remove the channel profile object 323 from the update profile region 320. The preset timing (e.g., Monday, Tuesday, Wednesday, etc.) may be set and changed by the terminal 100 and/or the server 200.

Referring to FIG. 5C, the terminal 100 may change a display state of the channel profile object 323 based on a preset timing. For example, when the application is activated on Friday, the terminal 100 may remove an advertisement guidance indicator (e.g., an AD user interface) from the channel profile object 323 in the update profile region 320. In the above example, when the application is activated on Saturday, the terminal 100 may display the channel profile object 323 together with the advertisement guidance indicator.

According to another embodiment, regardless of a preset timing, the terminal 100 may display the channel profile object 323, from which the advertisement guidance indicator is removed, together with the at least one updated other user profile object 321, 322, 324, 325, or 326.

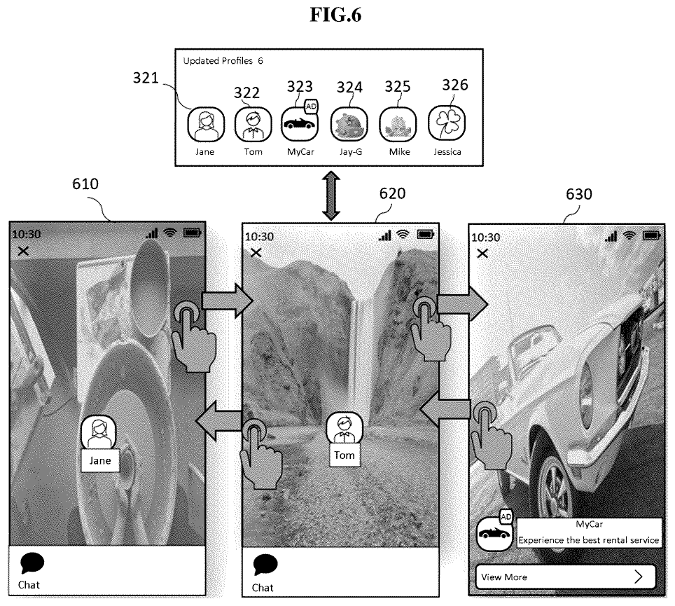

FIG. 6 is a drawing illustrating an example in which the terminal 100 displays a channel user interface.

According to various embodiments, in response to receiving a selection interaction for selecting one other user profile of the at least one other user profile object, the terminal 100 may display one other user interface corresponding to the selected other user profile object. For example, in response to receiving a selection interaction for selecting a first other user profile object 321, the terminal 100 may display a first other user interface 610. The first other user interface 610 may include image information, status information, and the like of the first other user profile object 321. In addition, in response to receiving a selection interaction for selecting a second other user profile object 322, the terminal 100 may display a second other user interface 620. The second other user interface 620 may include image information, status information, and the like of the second other user profile object 322.

According to various embodiments, in response to receiving a selection interaction for selecting one channel profile object among at least one channel profile object, the terminal 100 may display a channel user interface corresponding to the selected channel profile object. For example, when the terminal receives a selection interaction for selecting one channel profile object 323, the terminal 100 may display a channel user interface 630. The channel user interface 630 may include an advertising content, an advertising image, advertising link information, advertising status information, or the like of a channel account corresponding to the selected channel profile object 323.

According to various embodiments, the terminal 100 may match arrangement positions of the at least one other user profile object 321, 322, 324, 325, or 326 and the channel profile object 323 displayed in the update profile region 320 with arrangement positions of user interfaces corresponding to the respective profiles. For example, in the update profile region 320, a first other user profile object 321, a second other user profile object 322, a channel profile object 323, a third other user profile object 324, a fourth other user profile object 325, and a fifth other user profile object 326 may be sequentially displayed from one side (e.g., a left side based on the terminal 100). In the above example, in response to receiving a selection interaction for selecting the first other user profile object 321, the terminal 100 displays the first other user interface 610, and subsequently, in response to receiving a touch swipe interaction in a rightward direction, the terminal 100 may display the second other user interface 620. Thereafter, in response to receiving a touch swipe interaction in a rightward direction while the second other user interface 620 is being displayed, the terminal 100 may display the channel user interface 630. A user interface displayed according to each touch swipe may be configured to correspond to the arrangement positions of at least one other user profile object 321, 322, 324, 325, or 326 and the channel profile object 323 in the update profile region 320.

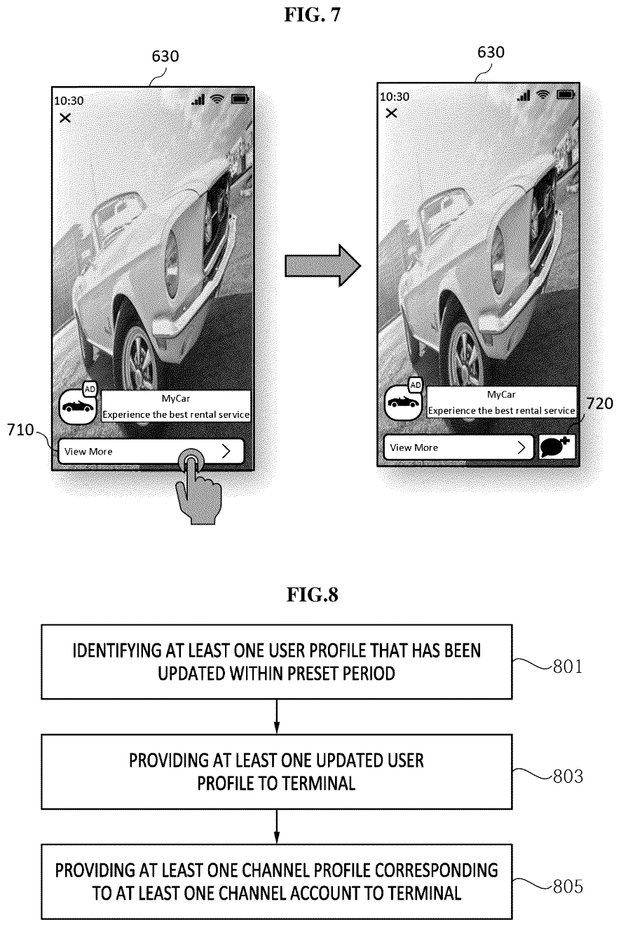

FIG. 7 is a drawing showing an example in which the terminal 100 displays a channel add interface within a channel user interface.

According to various embodiments, in response to receiving an interaction with a channel profile object, the terminal 100 may display a channel user interface 630 on a screen of the terminal 100. According to an embodiment, the channel user interface 630 may include a channel landing interface 710 that supports access to an advertising content provided by a channel account.

According to an embodiment, in response to receiving an interaction with the channel landing interface 710, the terminal 100 may display a landing user interface on a screen of the terminal 100. The landing user interface may include content related to text-based content, image advertising content, video content, and audio content provided by the channel account; promotion of products or services of the channel account; coupon promotion; product launch promotion; product news information; and the like. For example, the landing user interface may include vehicle information, vehicle rental prices, offline store locations, and advertising video content provided by a vehicle rental service channel account.

According to an embodiment, when the terminal 100 receives an interaction with the channel landing interface 710, the terminal 100 may display, within the channel user interface 630, a channel add interface 720 that supports a function for associating an account of the terminal with a channel account corresponding to a channel profile object. In response to receiving an interaction with the channel landing interface 710, the terminal 100 may display a landing user interface (e.g., an advertiser landing page, an advertiser landing video, etc.) on the screen of the terminal 100. Afterwards, when the terminal 100 displays the channel user interface 630 on the screen, the channel add interface 720 may be further displayed.

When the terminal 100 receives an interaction with the channel add interface 720, a preset relationship may be established between the account of the terminal 100 and the channel account. For example, the account “Peter” of the terminal 100 may establish a friend relationship with the channel “Car Rental Service” in the application and receive chat messages regarding discount coupon information, event information, news information, and the like from the channel “Car Rental Service.”

FIG. 8 is a flowchart illustrating an example in which the server 200 provides a channel profile object to the application.

In operation 801, the server 200 may identify at least one other user profile object updated within a preset period. At least one other user profile object updated within a preset period may be a user profile object corresponding to at least one other account associated with an account of the terminal 100.

According to an embodiment, the server 200 may identify an account updated within a preset period among a second account, a third account, and a fourth account which have established a preset relationship (e.g., a friend relationship) with a first account registered as a member of the application. The server 200 may determine whether profile information of each account registered as a member of the application has been updated. For example, when a background image of the profile of the second account in the application is changed, the server 200 may determine that the profile of the second account having a friend relationship with the first account has been updated.

In operation 803, the server 200 may provide at least one updated other user profile object to the terminal 100.

According to various embodiments, the server 200 may provide a user interface corresponding to the application to the terminal 100. According to an embodiment, the server 200 may provide a relevant function to display at least one updated other user profile object in a region of the user interface. For example, the server 200 may provide a relevant function or a user interface such that that the second, fourth, and sixth account profile objects, each of which has been updated, are sequentially displayed from one side in a region of the user interface.

In operation 805, the server 200 may provide at least one channel profile object corresponding to at least one channel account to the terminal 100.

According to various embodiments, the server 200 may provide a relevant function or a user interface such that at least one channel profile object corresponding to at least one channel account is displayed in a region of the user interface. According to an embodiment, the server 200 provides a relevant function or a user interface such that at least one channel profile object is displayed in a region of the user interface where updated other user profile objects are displayed. For example, the server 200 may provide a relevant function such that the second and fourth profile objects, each of which has been updated, are displayed in a region of the user interface with a channel profile object (e.g., an “A flower shop” channel profile object) being displayed between the second and fourth account profile objects.

According to various embodiments, the server 200 may determine an arrangement position of at least one channel profile object based on a selection interaction performed on the terminal 100 regarding the at least one updated other user profile object. For example, while the second and fourth account profile objects and the channel profile object, for which user profiles have been updated, are displayed in a region of the user interface, if the terminal 100 receives an interaction with the fourth account profile object, the server 200 may change the arrangement position of the channel profile object from a third position to a first or second position from one side. As another example, while the second and fourth account profile objects and the channel profile object, for which user profiles have been updated, are displayed in a region of the user interface, if an interaction is performed on the terminal 100 regarding the second and fourth account profile objects, the server 200 may change the arrangement position of the channel profile object from a third position to a first or second position from one side.

According to another embodiment, the terminal 100 may determine an arrangement position of at least one channel profile object in a region of the user interface, based on a selection interaction performed on the terminal 100 regarding at least one updated other user profile object. For example, while the second and fourth account profile objects and the channel profile object, for which user profiles have been updated, are displayed in a region of the user interface, if an interaction with the fourth account profile object is identified, the terminal 100 may change the arrangement position of the channel profile object from a third position to a first or second position from one side.

According to various embodiments, when a preset period has elapsed after displaying at least one channel profile object in a region, the server 200 may remove the at least one channel profile object. For example, when the preset period has elapsed, the server 200 may remove an “A” channel profile object. The preset period may be set by the server 200, for example, 24 hours after the “A” channel profile object is displayed. As another example, when the preset period has elapsed after displaying at least one channel profile object in a region, the server 200 may not provide information on the at least one channel profile object to the terminal 100.

According to yet another embodiment, when the preset period has elapsed after displaying at least one channel profile object in a region, the terminal 100 may remove the at least one channel profile object. For example, when the preset period has elapsed, the terminal 100 may remove an “A” channel profile object from a region of the user interface. As another example, when the preset period has elapsed after displaying at least one channel profile object in a region, the terminal 100 may not receive information on the at least one channel profile object from the server 200.

According to yet another embodiment, when no other user profile has been updated, the server 200 may also not display a channel profile object in a region of the user interface. According to an additional embodiment, even when no other user profiles have been updated, the server 200 may display only a channel profile object in a region of the user interface. According to an additional embodiment, when no other user profile has been updated, the terminal 100 may not display the channel profile object in a region of the user interface.

According to an embodiment, when the preset period has elapsed after displaying the at least one channel profile object, the server 200 may change at least one channel profile object to another channel profile object corresponding to at least one channel account. For example, when 24 hours have elapsed after displaying an “A car” channel profile object in a region of the user interface, the server 200 may change a sedan-image profile object provided by the “A car” channel account to a sports-car-image profile object.

According to yet another embodiment, when a preset period has elapsed after displaying at least one channel profile object in a region of the user interface, the server 200 may change the at least one channel profile object to another channel profile object corresponding to another channel account. For example, when 24 hours have passed after displaying an “A car” channel profile object, the server 200 may change the “A car” channel profile object to a “B flower shop” channel profile object provided by a “B flower shop” channel account.

According to various embodiments, the server 200 may provide a relevant function or a user interface such that, when a selection interaction is performed on the terminal 100 regarding one channel profile object among at least one channel profile object, a channel user interface corresponding to the one other channel profile object is displayed on a screen of the terminal 100. For example, when an interaction is performed on the terminal 100 regarding an “A car” channel profile object, the server 200 may provide a relevant function to display an “A car” channel user interface corresponding to the “A car” channel profile object. The “A car” channel user interface may include information on the “A car” channel profile object, product/service information provided via the “A car” channel, advertising content, and link information for accessing the “A car” channel account.

According to another embodiment, when a selection interaction is performed on the terminal 100 regarding one other user profile object among the at least one channel profile object, the terminal 100 may display a channel user interface corresponding to the one channel profile object on a screen. For example, when an interaction with an “A car” channel profile object is detected, the terminal 100 may display an “A car” channel user interface corresponding to the “A car” channel profile object.

According to various embodiments, the server 200 may provide a relevant function such that, when a touch swipe interaction is performed on the terminal 100 regarding a channel user interface, a profile user interface corresponding to at least one other user profile object is displayed. According to another embodiment, when a touch swipe interaction with a channel user interface is identified, the terminal 100 may display a profile user interface corresponding to at least one other user profile object on the screen of the terminal 100.

The server 200 may provide a function to determine a profile user interface to be displayed on the terminal 100 based on a direction of the touch swipe interaction. For example, when a first account profile, a second account profile, and a channel profile object, which have been updated, are displayed in a region of the user interface of the terminal 100, the server 200 may provide a relevant function such that, when a touch swipe interaction in a rightward direction from one side is performed while a profile user interface corresponding to the first account profile object is displayed, a profile user interface corresponding to the second account profile is displayed. Thereafter, the server 200 may provide a relevant function such that, when a touch swipe interaction in a rightward direction from on one side is performed on the terminal 100 while a profile user interface corresponding to the second account profile object is displayed, a channel user interface corresponding to the channel profile object is displayed.

According to various embodiments, the server 200 may provide a relevant function such that, when an interaction is performed on the terminal 100 regarding a channel landing interface included in the channel user interface, a landing user interface corresponding to the channel landing interface is provided to the terminal 100. According to yet another embodiment, when an interaction with a channel landing interface included in a channel user interface is identified, the terminal 100 may display a landing user interface corresponding to the channel landing interface on the screen of the terminal 100. The channel landing interface may be an interface that allows access to information on products or services provided by the channel account, advertising content provided by the channel account, and the like.

According to an embodiment, after the terminal 100 accesses content through the channel landing interface, the server 200 may provide, in the channel user interface, a channel add interface that supports a function for associating the account of the terminal 100 with the channel account. For example, when an interaction is performed on the terminal 100 regarding a channel landing interface in an “A clothing” channel user interface, the server 200 may provide a relevant function to play back advertising video content provided by the “A clothing” channel account. Thereafter, when the terminal 100 displays the “A clothing” channel user interface, the server 200 may provide a relevant function to display a channel ad interface for adding the “A clothing” channel in a region of the user interface. In this case, adding the “A clothing” channel may refer to establishing a friend relationship between the account of terminal and the corresponding channel to consent to exchanging messages with the channel account and receiving advertising messages via a chat room.

According to various embodiments, the server 200 may determine at least one channel profile object to be displayed in a region of the user interface, based on at least one of: gender information at least one other user profile object, age information of the at least one other user profile object, and association information with at least one channel corresponding to the at least one other user profile object.

According to an embodiment, the server 200 may identify gender information of at least one other account, having an updated user profile, in a region of the user interface. For example, the server 200 may identify that gender information of the first account having an updated user profile is female, gender information of the second account is female, and gender information of the third account is male. In the above example, based on the gender information of the first account being female and the gender information of the second account being female, the server 200 may determine the channel profile object to be a channel profile object corresponding to a cosmetics brand or a women's fashion brand preferred by women. The server 200 may provide a relevant function such that the first account profile object, the channel profile object corresponding to the cosmetics brand or a women's fashion brand, the second account profile object, and the third account profile object are displayed in a region of the user interface. A type of channel profile object determined based on gender information may be set and changed by the server 200.

According to an embodiment, the server 200 may identify age information of at least one other account having an updated user profile in a region of the user interface. For example, when age information of a first account having an updated user profile is in the 20s, age information of a second account is in the 30s, and age information of a third account is in the 30s, the server 200 may determine an arrangement position of a channel profile object to be between the second account and the third account based on the age information of the second account and the age information of the third account being in the 30s. In addition, based on the age information of the second account and the age information of the third account being in the 30s, the server 200 may determine the channel profile object to be a healthy food channel profile object preferred by users in their 30s. The server 200 may provide a relevant function such that a first account profile object, a second account profile object, a healthy food channel profile object, and a third account profile object are displayed in a region of the user interface. A type of channel profile object determined based on age information may be set and changed by the server 200.

According to an embodiment, the server 200 may determine at least one channel profile object to be displayed in a region of the user interface, based on association information with at least one channel corresponding to the at least one channel profile object. For example, when a friend relationship is established with ‘A Fashion Channel’ among a first account, a second account, and a third accounts, each of which a user profile has been updated, in a region of the user interface, the server 200 may provide a relevant function or a user interface such that ‘A Fashion Channel profile object’ is displayed between the first account profile object and the second account profile object.

According to various embodiments, the server 200 may determine a channel profile object to be displayed in a region of the user interface, based on a combination of gender information of at least one other user profile object, age information of the at least one other user profile object, and association information with at least one channel corresponding to the at least one channel profile object. For example, when the gender information of the first and second accounts is female and the age information of the first and second accounts is in the 20s, the server 200 may determine a skin care channel profile object preferred by women in their 20s. As yet another example, when the first and second accounts are males in the 30s, the server 200 may determine an SUV car channel profile object preferred by male in their 30s as the channel profile object to be displayed in a region of the user interface.

At least a portion of an apparatus (e.g., modules or functions thereof) or a method according to various embodiments may be implemented by instructions (e.g., a computer program) stored in a computer-readable storage medium, for example, in the form of a program module. According to an embodiment, when an instruction is executed by a processor (e.g., the processor 110, the processor 210, etc.), one or more processors may perform a function corresponding to the instruction. A computer-readable storage medium may be, for example, a memory (e.g., the memory 120, the memory 250, etc.).

A computer-readable recording medium may include a hard disk, a floppy disk, magnetic media (e.g., magnetic tape), optical media (e.g., compact disc read only memory (CD-ROM), digital versatile disc (DVD)), magneto-optical media (e.g., floptical disk), and hardware devices (e.g., read only memory (ROM), random access memory (RAM), or flash memory, etc.) specifically configured to store and perform program instructions. In addition, program instructions may include not only machine language code, such as that produced by a compiler, but also high-level language code that may be executed by a computer using an interpreter or the like. The hardware devices described above may be configured to operate as one or more software modules to perform operations of various embodiments, and vice versa.

Technical features disclosed in each embodiment of the present disclosure are not limited to the corresponding embodiment, and the technical features disclosed in each embodiment may be combined and applied to different embodiments unless they are mutually incompatible. Those skilled in the art will further understand that any disjunctive words and/or phrases indicating two or more alternative terms, whether in the detailed description, claims, or drawings, are to be understood as contemplating the possibility of including one of the terms, either of the terms, or both terms. For example, the phrase “A or B” is to be understood as including the possibility of “A”, “B”, or “A and B”. In addition, the term “each,” as used herein, in addition to its ordinary meaning, may mean any subset of a set of elements to which the term “each” applies. In addition, the term “each,” as used herein, in addition to its ordinary meaning, may mean any subset of a set of elements to which the term “each” applies. Conjunctive language such as the phrase “at least one of X, Y, and Z,” unless specifically stated otherwise, is understood in the context generally used to convey that an item, term, etc., may be X, Y, or Z. Such conjunctive language is not generally intended to imply that a particular embodiment requires the presence of at least one of X, at least one of Y, and at least one of Z.

Therefore, although each embodiment is described focusing on its respective technical features, the technical features may be applied in combination with each other as long as they are not mutually incompatible.

The present disclosure may provide various technical effects and innovations. For example, by displaying a channel profile in a specific region of a user interface, access by a user account to channel content provided by a channel account may be facilitated. This allows for quickly and easily providing an experience of channel content (e.g., advertising content, product/service-related content, etc.) to the terminal account.

In addition, by displaying the channel profile in a region of the user interface to minimize a terminal user's interaction for accessing the channel content provided by the channel account, resources of related data may be saved, and power consumption of an electronic device and server load may be reduced. This allows for contributing to saving computing resources (e.g., terminals, servers, etc.).

Furthermore, by determining a type of the channel content based on profile information (e.g., gender, age, subscription status, etc.) associated with an updated profile of a friend, the relevance and accessibility of the channel content may be significantly improved. This provides the user account with a more enriched and personalized experience of the channel content. Accordingly, such technical improvements may lead to an improved click-through rate for the channel account and increased conversion rates for products or services provided through the channel content

The present disclosure is not limited to the above-described embodiments and the accompanying drawings, and various modifications and variations are possible from the viewpoint of a person skilled in the art to which the present disclosure pertains. Therefore, the scope of the present disclosure should be defined not only by the claims of this specification but also by equivalents thereof.

What is claimed is:

1. A method for providing a channel profile object in a terminal, comprising:
receiving an interaction for activating a user interface comprising the channel profile object; and
displaying the user interface on a screen of the terminal,
wherein the user interface includes a region in which a plurality of profile objects is sequentially arranged and displayed,
wherein the plurality of profile objects comprise at least one other user profile object updated within a preset period and at least one channel profile object corresponding to the at least one channel account,
wherein the at least one updated other user profile object is a user profile object corresponding to at least one other account associated with an account of the terminal.

2. The method of claim 1, wherein the at least one channel profile object has an arrangement position that is determined in the region based on a selection interaction information performed on the terminal regarding the at least one updated other user profile object.

3. The method of claim 1, further comprising removing the at least one channel profile object when a preset period has elapsed after displaying the at least one channel profile object in the region.

4. The method of claim 1, further comprising changing the at least one channel profile object to another channel profile object corresponding to the at least one channel account, when a preset period has elapsed after displaying the at least one channel profile object in the region.

5. The method of claim 1, further comprising, in response to a selection interaction for selecting one other profile object among the at least one channel profile object, displaying a channel user interface corresponding to the selected other channel profile object.

6. The method of claim 5, further comprising:
receiving a touch swipe interaction with the channel user interface; and
in response to the touch swipe interaction, displaying a profile user interface corresponding to one other user profile of the at least one other user profile object, wherein the profile user interface is determined based on an arrangement position of the one other user profile in the region.

7. The method of claim 5, further comprising:
receiving an interaction with a channel landing interface included in the channel user interface;
displaying a landing user interface corresponding to the channel landing interface; and
displaying, in the channel user interface, a channel add interface that supports a function for associating an account of the terminal with a channel account corresponding to the one other channel profile object.

8. The method of claim 1, wherein the at least one channel profile object is determined based on at least one of: gender information of the at least one other user profile object; age information of the at least one other user profile object; and association information with at least one channel corresponding to the at least one channel profile object.

9. A terminal for providing a channel profile object, comprising:
a memory storing instructions, and
a processor configured to execute the instructions to:
receive an interaction for activating a user interface comprising the channel profile object; and
display the user interface on a screen of the terminal,
wherein the user interface includes a region in which a plurality of profile objects is sequentially arranged and displayed,
wherein the plurality of profile objects comprise at least one other user profile object updated within a preset period and at least one channel profile object corresponding to the at least one channel account,
wherein the at least one updated other user profile object is a user profile object corresponding to at least one other account associated with an account of the terminal.

10. A method performed by a server for providing a channel profile object, comprising:
identifying for at least one other user profile object that has been updated within a preset period, wherein the at least one updated other user profile object is a user profile object corresponding to at least one other account associated with an account of a terminal;
providing the at least one updated other user profile object to the terminal; and
providing at least one channel profile object corresponding to at least one channel account to the terminal, wherein a user interface of the terminal includes a region in which a plurality of profile objects is sequentially arranged and displayed, the plurality of profile objects comprising the at least one channel profile object and the at least one updated other user profile object.

11. The method of claim 10, wherein the at least one channel profile object has an arrangement position that is determined in the region based on a selection interaction performed on the terminal regarding the at least one updated other user profile object.

12. The method of claim 10, further comprising removing the at least one channel profile object when a preset period has elapsed after displaying the at least one channel profile object in the region.

13. The method of claim 10, further comprising changing the at least one channel profile object to another channel profile object corresponding to the at least one channel account, when a preset period has elapsed after displaying the at least one channel profile object in the region.

14. The method of claim 10, further comprising, in response to a selection interaction performed on the terminal regarding one other channel profile object among the at least one channel profile object, providing a channel user interface corresponding to the one other channel profile object to the terminal.

15. The method of 14, further comprising, in response to a touch swipe interaction performed on the terminal regarding the channel user interface, providing a profile user interface corresponding to the at least one other user profile object to the terminal,
wherein the profile user interface is determined based on an arrangement position of the one other user profile object in the region.

16. The method of 14, further comprising:
in response to an interaction performed on the terminal regarding a channel landing interface included in the channel user interface, providing a landing user interface corresponding to the channel landing interface to the terminal; and
providing, in the channel user interface, a channel add interface that supports a function for associating the account of the terminal with a channel account corresponding to the one other channel profile object.

17. The method of claim 10, wherein the at least one channel profile object is determined based on at least one of: gender information of the at least one other user profile object; age information of the at least one other user profile object; and association information with at least one channel corresponding to the at least one channel profile object.
